(19) United States
(12) Patent Application Publication
(10) Pub. No.: US 2026/0286932 A1
(43) Pub. Date: Sep. 24, 2026

(54) PULTRUDED PLANK, SPAR CAP, WIND TURBINE BLADE, AND PULTRUSION PREPARATION PROCESS

(71) Applicant: Owens Corning Intellectual Capital, LLC, Toledo, OH (US)

(72) Inventors: Jansy Peng, Hangzhou (CN); Jinchun Zhu, Hangzhou (CN); Bowen Zhang, Hangzhou (CN); Jianfeng Shi, Hangzhou (CN)

(73) Assignee: Owens Corning Intellectual Capital, LLC, Toledo, OH (US)

(21) Appl. No.: 19/473,918

(22) PCT Filed: Apr. 5, 2024
(86) PCT No.: PCT/US2024/023179

§ 371 Date: Oct. 9, 2025

(30) Foreign Application Priority Data
Apr. 14, 2023 (CN) 202310403089.5

(51) Int. Cl. F03D 1/06; B29C 70/52; B29L 31/08

(52) U.S. Cl. CPC F03D 1/0681; B29C 70/521; B29L 2031/085

(57) ABSTRACT

The present application discloses a pultruded plank, a spar cap, a wind turbine blade, and a pultrusion preparation process. The pultruded plank comprises a pultruded core and a coated interface layer. The pultruded core is made with reinforced fibers impregnated with a core resin. The interface layer is made with an interface resin present on at least one surface of the pultruded core, and allows the pultruded plank to be wound and packaged after manufacturing. The interface resin contains an isocyanate resin and a polyester resin, and the mass ratio of the isocyanate resin to the polyester resin is 1:3~2:3. The surface of the interface layer forms a bonded surface on the pultruded plank, and the bonded surface is used to form a bonding interface between at least two pultruded planks.

### CROSS-REFERENCE TO RELATED APPLICATION(S)

This application claims priority to Chinese Patent Application No. 202310403089.5 filed on Apr. 14, 2023, the disclosure of which is incorporated by reference herein in its entirety.

### BACKGROUND

The present application relates to the technical field of composite materials, and specifically to a pultruded plank, a spar cap, a wind turbine blade, and a pultrusion preparation process.

The pultruded plank is usually fiber reinforced resin composite. For example, the pultruded plank may be glass fiber or carbon fiber reinforced composite slats, wherein the structurally reinforced fiber extends along the length direction of the plank, which thereby endows it with strong tensile strength and high load-carrying capacity. Such planks can be stacked with each other and bonded together by the infusion resin to form laminated components with structural characteristics suitable for strengthening wind turbine blades, such as the spar cap.

However, pultrusion usually causes planks to have very smooth bonded surfaces, which is difficult to be bonded firmly. Moreover, when the planks are stacked, the smooth surfaces of the planks fit with each other, resulting in few gaps for the resin to penetrate between the adjacent planks.

Therefore, the surfaces of the planks usually need to be treated, e.g., polished to rough the surface, before the planks are glued together. However, such polishing often damages the reinforced fibers located near the surface, affecting the mechanical property of the planks.

At present, an alternative is to configure a stripping layer on the surface of the planks and remove the stripping layer from the planks before stacking the planks so as to create a rough bonded surface. However, setting up a stripping layer will cause some additional drawbacks. For example, during the pultrusion process, the stripping layer may be hooked into the pultrusion die, which affects the production process and also increases the cost of pultrusion process; and once the stripping layer is removed, it will cause damage to the fiber and also affect the mechanical property of the planks. In addition, the additional stripping layer will increase product costs, resulting in higher production costs of downstream products such as the spar cap.

Therefore, a pultruded plank, a spar cap, a wind turbine blade, and a pultrusion preparation process are needed to at least partially solve the above problem.

### SUMMARY

A series of simplified concepts is introduced into the portion of Summary, which would be further illustrated in the portion of the detailed description. The Summary of the present application does not mean attempting to define the key feature and essential technical feature of the claimed technical solution, let alone determining the protection scope thereof.

To at least partially solve the problem, the first aspect of the present application provides a pultruded plank, which is used for a spar cap of a wind turbine blade, comprising:
a pultruded core made with reinforced fibers impregnated with a core resin, the reinforced fibers including glass fibers and/or carbon fibers;
a coated interface layer made with an interface resin present on at least one surface of the pultruded core, the interface layer allowing the pultruded plank to be wound and packaged after manufacturing, the interface resin containing an isocyanate resin and a polyester resin, and a mass ratio of the isocyanate resin to the polyester resin being 1:3~2:3;
wherein a surface of the interface layer forms a bonded surface on the pultruded plank, and the bonded surface is used to form a bonding interface between at least two pultruded planks.

The pultruded plank according to this application provides a sanded-free interface layer bonded surface without affecting the winding and packaging, which will not cause damage to the reinforced fibers, so that the pultruded plank will not lose mechanical properties; and stacking and perfusion can be performed directly during the laminated infusion process to form the spar cap, without the need for additional surface activation of the plank and eliminating the use of consumables such as stripper cloth, which reduces production costs.

The pultruded core is formed by dragging the reinforced fibers impregnated with the core resin through a pultrusion die for heating and solidifying.

The interface layer is obtained by coating the interface resin on at least one surface of the pultruded core through a roller coating, brush coating or glue injection mold process and hardening.

The bonded surface without sanding can be used to form the bonding interface between at least two pultruded planks bonded with an infusion resin in the process of forming at least two of the pultruded planks by stacking and forming the spar cap by a laminated infusion process.

Further, the interface layer is formed through a glue injection mold process. The glue injection mold is located downstream of the pultrusion die along a dragging direction and comprises an inlet, an outlet, and a glue injection port arranged between the inlet and the outlet. The height size of a cavity in the glue injection mold decreases gradually along the dragging direction such that the outlet size of the glue injection mold can define the interface layer to have a predetermined thickness.

The pultruded core is dragged from an inlet of the glue injection mold into the glue injection mold, and is dragged through the outlet after receiving the interface resin via the glue injection port to form a ungelled interface layer with the predetermined thickness on a surface of the pultruded core. According to the above settings, forming the interface layer by using the glue injection mold can realize continuous production and directly form the interface layer with the predetermined thickness, which is of high efficiency and makes the thickness of the interface layer uniform.

Further, before the pultruded plank is wound and packaged, a temperature greater than 100° C. is applied to the interface layer by a supplementary heating device for heating such that the interface layer is hardened to avoid adhesion of the interface layer during winding and packaging;

wherein the supplementary heating device is located downstream of the glue injection mold along the dragging direction. According to the above settings, the hardened surface of the interface layer is formed before winding and packaging, avoiding the adhesion phenomenon between the pultruded planks after the winding and improving the quality of the product.

Further, the surface of the interface layer is provided with a texture formed when the interface layer is not cured by a texture applying device that is located between the glue injection mold and the supplementary heating device and comprises a scraping plate or a stamp of a texture shape. According to the above settings, the texture not only improves the surface roughness and thereby improves the interlayer adhesion, but also can be used as a flow channel of the infusion resin during the laminated infusion, so as to ensure that the infusion resin fully soaks and moistens the pultruded plank and fiber fabric layers.

Further, a shape of the texture is constructed to be irregularly striped, latticed or scattered. According to this solution, the choice of texture is diverse and the design is of high freedom.

Further, the interface layer has the predetermined thickness of 0.02 to 0.2 mm; and/or
a thickness of the texture is the same as the predetermined thickness of the interface layer. According to the above settings, the thickness of the texture can be selected freely. Making the texture have the same thickness as the interface side further improves the roughness, and enables the infusion resin to be bonded to both the interface layer and the pultruded core at the same time, thus improving the bonding reliability.

Further, the mass ratio of the isocyanate resin to the polyester resin is 1:3~1:2.

Further, the isocyanate resin contains diphenyl methane diisocyanate; and/or
the polyester resin contains a bisphenol A type polyester resin and a reaction accelerator.

The second aspect of the present application provides a spar cap of a wind turbine blade, comprising the pultruded plank of the first aspect.

The spar cap according to this application has the above-mentioned pultruded plank and is therefore capable of achieving technical effects similar to those of the pultruded plank in the first aspect.

The third aspect of the present application provides a wind turbine blade, comprising the pultruded plank of the first aspect, or the spar cap of the second aspect.

The wind turbine blade according to this application has the pultruded plank or the spar cap and is therefore capable of achieving technical effects similar to those of the pultruded plank in the first aspect.

The fourth aspect of the present application provides a pultrusion preparation process for making a pultruded plank for a spar cap of a wind turbine blade, wherein at least two of the pultruded planks form the spar cap by stacking and a laminated infusion process, comprising:
a step of forming a core in which a pultruded core of the pultruded plank is formed by dragging reinforced fibers impregnated with a core resin through a pultrusion die for heating and solidifying;
a step of forming an interface layer in which an interface resin is coated on at least one surface of the pultruded core through a glue injection mold process, and the interface layer is defined to have a predetermined thickness when not gelled, wherein the interface layer allows the pultruded plank to be wound and packaged after hardening, and defines a bonded surface of the pultruded plank, the interface resin containing an isocyanate resin and a polyester resin, and a mass ratio of the isocyanate resin to the polyester resin being 1:3~2:3;
a winding step in which the pultruded plank is wound and packaged after the interface layer is hardened.

The pultrusion preparation process according to this application forms a sanded-free interface layer bonded surface without affecting the winding and packaging, and the bonded surface will not cause damage to the reinforced fibers, so that the pultruded plank will not lose mechanical properties; and the pultruded plank formed by this pultrusion preparation process can be stacked and infused directly during the laminated infusion process to form the spar cap, without the need for additional surface activation of the plank and eliminating the use of consumables such as stripper cloth, which reduces production costs.

Further, the step of forming the interface layer further comprises: applying a texture to a surface of the interface layer after the interface layer has a predetermined thickness and before the interface layer is gelled. According to the above settings, the roughness of the interface layer can be improved, thereby improving the interlayer bonding force and also enabling the infusion resin to be fully filled between the adjacent interface layers during laminated infusion.

Further, the step of forming the interface layer further comprises: performing supplementary heating on the pultruded plank before winding and packaging at a supplementary heating temperature greater than 100° C. According to the above settings, the interface layer can form a hardened surface to avoid adhesion between the pultruded planks when wound.

### BRIEF DESCRIPTION OF THE DRAWINGS

The following drawings are hereby incorporated as part of the present application for the understanding of the present application. The embodiments are illustrated and described in the drawings in order to explain the principles of the present application.

In the drawings:

FIG. 1 shows a structure diagram of a wind turbine blade according to an embodiment of the present application;

FIG. 2 shows a structure diagram of a pultruded plank according to an embodiment of the present application;

FIG. 3 shows a texture diagram of the pultruded plank according to an embodiment of the present application;

FIG. 4 shows a schematic diagram of a preparation process of the pultruded plank according to an embodiment of the present application;

FIG. 5 shows a schematic diagram of a glue injection mold;

FIG. 6 shows a flow diagram of a pultrusion preparation process according to an embodiment of the present application;

FIG. 7 shows a more detailed flow diagram of the pultrusion preparation process according to an embodiment of the present application; and

FIG. 8 shows a diagram of implementing a laminated infusion process of the pultruded plank according to an embodiment of the present application.

EXPLANATION OF REFERENCE NUMBERALS

| | | |
|---|---|---|
| 10: Wind turbine blade | 11: Windward housing | 12: Leeward housing |
| 13: Interlayer region | 14: Shear beam | 20: Spar cap |
| 100: Pultruded plank | 110: Pultruded core | 111: Fiber |
| 120: Interface layer | 1: Fiber yarn | 2: Core resin tank |
| 3: Pultruded die | 4: Glue injection mold | 5: Texture applying |
| | | device |
| 6: Supplementary | 7: Tractor | 100R: Pultruded plank |
| heating device | | roll |
| 41: Inlet | 42: Outlet | 43: Glue injection port |
| 15: Housing fabric | 8: Flow guide fabric | |

### DETAILED DESCRIPTION

In the following description, numerous specific details are set forth in order to provide a more thorough understanding of the present application. However, it is obvious to those skilled in this art that the present application may be implemented without one or more of these details. Some technical features well-known in this art are not described in other examples in order to avoid confusion with the present application.

It shall be noted that the terminology used herein is for the purpose of describing particular embodiments only and is not intended to limit the exemplary embodiments of the present application. As used herein, the singular forms are intended to include the plural forms as well, unless the context clearly indicates otherwise. It will be further understood that the terms “comprising” and/or “including,” when used in this specification, specify the presence of stated features, wholes, steps, operations, elements, and/or components, but do not preclude the presence or addition of one or more other features, wholes, steps, operations, elements, components, and/or combinations thereof.

Ordinals such as “first” and “second” quoted in this application are merely identifiers and do not carry any other meaning, such as a specific order. Moreover, for example, the term “first component” itself does not imply the presence of “second component”, and the term “second component” itself does not imply the presence of “first component”. It should be noted that the terms “up”, “down”, “front”, “back”, “left”, “right”, “inside”, “outside” and similar expressions used herein are for illustrative purposes only and are not restrictive.

The exemplary embodiments of the present application will now be explained in further details with reference to the accompanying drawings.

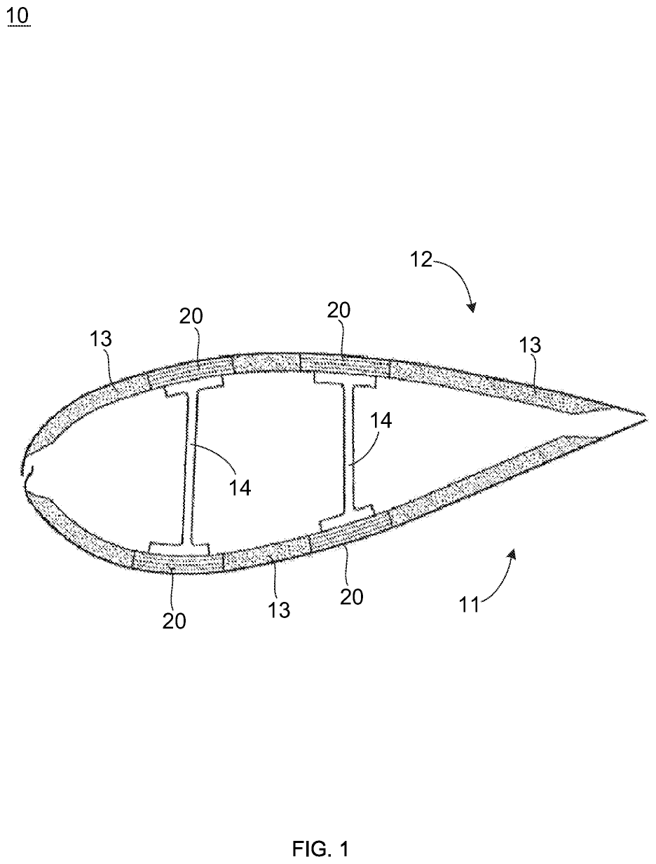

As shown in FIG. 1, the present application provides a wind turbine blade 10, which usually has a housing consisting of two half housings such as windward housings 11 and leeward housings 12, wherein each half housing may have an interlayer region 13 and a non-interlayer region 13. The interlayer region 13 includes a coating made of a fiber-reinforced resin composite (e.g., glass fiber reinforced plastic) and a lightweight foam core (e.g., polyurethane foam core) sandwiched between the two coatings.

The non-interlayer region 13 may be provided with a spar cap 20, that is, the spar cap 20 is arranged between two interlayer regions 13, and the spar cap 20 can be formed integrally with the interlayer region 13. The spar cap 20 on windward housing 11 and the spar cap 20 on leeward housing 12 are arranged opposite, and a shear beam 14 is preferably provided between them. The shear beam 14 and the spar cap 20 on the two half housings form a type I structure, which thereby can effectively transfer the load from the wind turbine blade 10 to the wind turbine hub, wherein the spar cap 20 can transfer the bending load of tension and compression, and the shear beam 14 can transfer the shear stress.

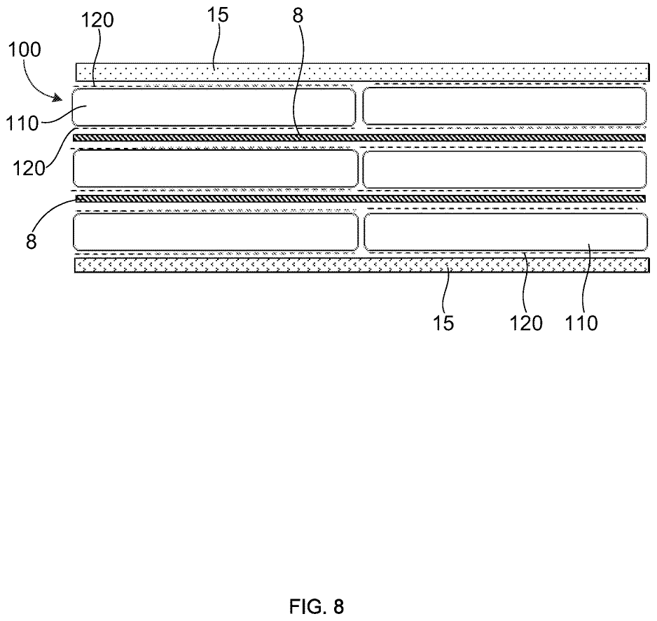

The spar cap 20 is made of several stacked pultruded planks 100. With reference to FIG. 8, exemplarily, multiple pultruded planks 100 can be stacked and spliced to bundle and fix into a whole or partial prefabricated component of the spar cap 20. When stacked, fiber flow guide fabric 8 is laid between the layers of the plank, and housing fabric 15 is laid on the outermost layer. The housing fabric 15 can be made of the same material as the coating of the interlayer region 13, or the two can be integral. The prefabricated planks are placed in an infusion mold along with other components for making the blades. The mold is then imported with the infusion resin by applying a vacuum to the mold. The vacuum pressure makes the gaps between the layers of the planks and parallel splicing planks full of the infusion resin. Further, the spar cap 20 is formed by curing the infusing resin.

It should be noted that several pultruded planks 100 can be stacked and imported with the infusion resin, and the resin is solidified to form a finished spar cap 20. Then the finished spar cap 20 is placed into the mold of half blade (or half housing) of the wind turbine to introduce the infusion resin, so that the gap between the spar cap 20 and other components and the housing fiber laminated layer is filled with the infusion resin. The half blade is thereby formed by curing the infusion resin.

An integral half blade can also be made by infusing the resin while making the blade as a whole after the pultruded plank 100 and other components are fixed into prefabricated components.

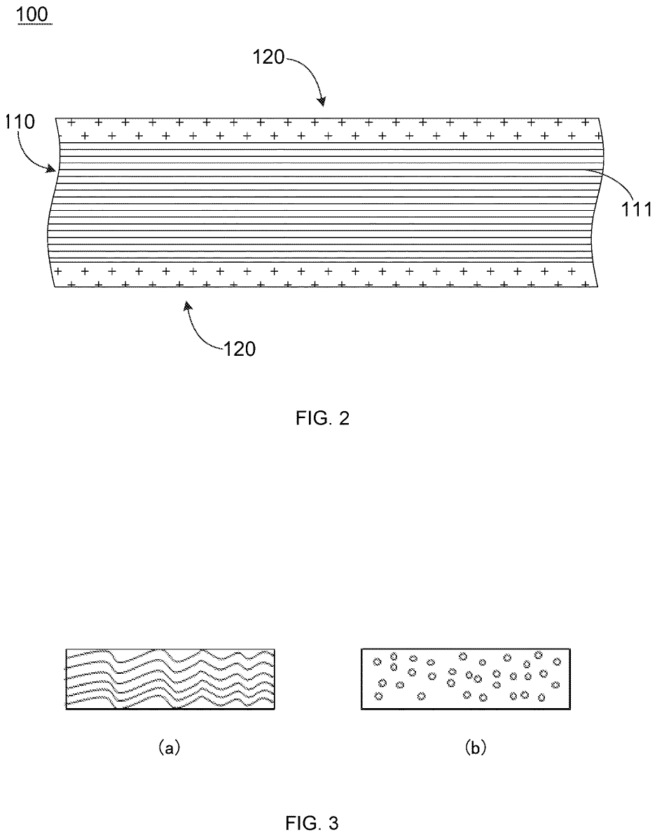

Reference can be made to FIG. 2 to FIG. 5 for the pultruded plank 100. The pultruded plank 100 includes a pultruded core 110 and an interface layer 120, which is located on at least one surface of the pultruded core 110 to define the bonded surface of the pultruded plank 100. The bonded surface without sanding can be used to form the bonding interface between at least two pultruded planks bonded with the infusion resin in the process of forming the spar cap 20 by the laminated infusion process.

Wherein, the pultruded core 110 comprises a core resin and a fiber 111 arranged in the core resin. The pultruded core 110 is formed by dragging the fiber 111 impregnated with the core resin through a pultrusion die 3, and being heated and solidified by the pultrusion die 3.

The interface layer 120 consists of an interface resin, which is a curable resin with fluidity before curing and a dry and hardened surface after curing. Preferably, the interface resin can be a compound resin. Since the pultruded core 110 made by the pultrusion die 3 can be partially cured or nearly completely cured, the undercoated resin with low viscosity, high polarity and high flexibility can be selected as the interface layer in order to ensure the adhesion between the interface resin and the core.

The interface layer 120 is obtained by coating the interface resin on at least one surface of the pultruded core 110 through a roller coating, brush coating or glue injection mold process and hardening, wherein the interface layer 120 is defined to have a predetermined thickness before gelling or without hardening, with the predetermined thickness of 0.02 to 0.2 mm, preferably 0.03 to 0.09 mm, and the interface layer 120 allows the pultruded plank 100 to be wound and packaged after hardening. The hardened surface of the interface layer 120 forms a bonded surface of the pultruded plank 100. The hardened interface layer 120 has a thickness of 0.02 to 0.2 mm, preferably 0.03 to 0.09 mm. Optionally, the predetermined thickness may be defined by the outlet size of the rod roll coating or glue injection mold 4.

The pultruded plank 100 according to this application provides a sanded-free interface layer 120 bonded surface without affecting the winding and packaging, which will not cause damage to the reinforced fibers, so that the pultruded plank 100 will not lose mechanical properties; and stacking and infusion can be performed directly during the laminated infusion process to form the spar cap 20, without the need for additional surface activation of the plank and eliminating the use of consumables such as stripper cloth, which reduces production costs.

As an implementation, the surface of the interface layer 120 can be rough. For example, a texture can be set on the surface of the interface layer 120. Thus, this not only improves the adhesion by higher surface roughness, but also uses the gaps formed by the texture to provide a flow channel for the infusion resin to be filled between the pultruded planks 100. Optionally, the shape of the texture is constructed to be irregularly striped, latticed or scattered. For example, FIG. 3(a) shows a striped texture, and FIG. 3(b) shows a scattered texture.

Further, the texture can have a thickness of 0.02 to 0.2 mm, preferably 0.03 to 0.09 mm. Specifically, the thickness of the texture can be less than the thickness of the interface layer of 120. Alternatively, the thickness of the texture may be the same as the predetermined thickness of the interface layer 120, that is, the surface of the pultruded core 110 can be exposed by applying the texture. As a result, not only the roughness is further improved, but also the infusion resin can be bonded to both the interface layer 120 and the pultruded core 110 at the same time, thus improving the bonding reliability.

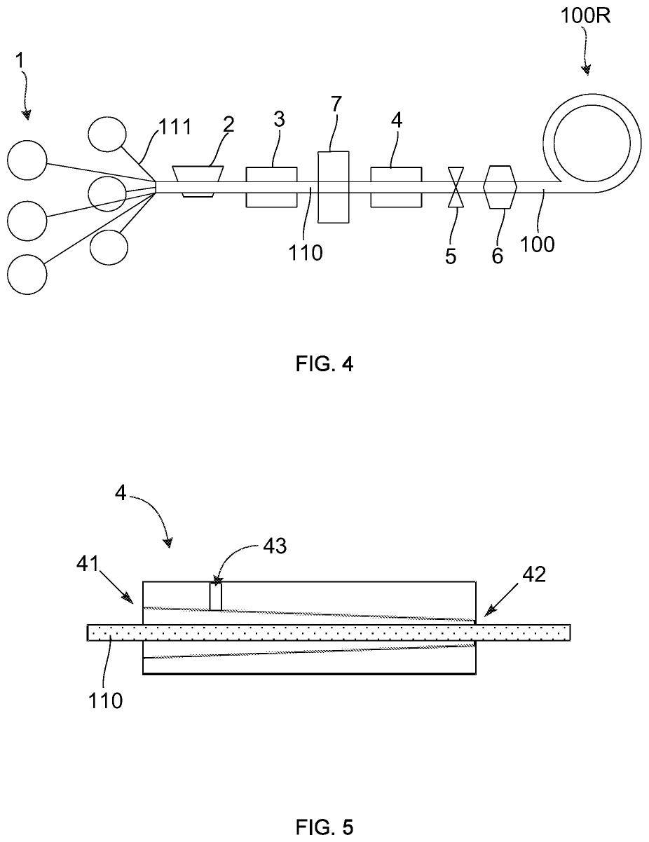

Reference can be made to FIG. 4 for specific preparation process of the pultruded plank 100. The pultruded core 110 is formed by the pultrusion process. Firstly, fiber 111 is extracted from the fiber yarn 1 by the tractor 7 and passes through the resin tank 2 to infiltrate the core resin, and then heated by the pultrusion die 3 to solidify the core resin and form the pultruded core 110.

After that, the tractor 7 is utilized to drag the pultruded core 110 further to the glue injection mold 4 located downstream of the pultrusion die 3 to implement the glue injection process to form an unhardened or ungelled interface layer 120 with a predetermined thickness. Wherein, referring to FIG. 5, the glue injection mold 4 has an inlet 41, an outlet 42 and a glue injection port 43 between the inlet 41 and outlet 42, and the height size of the cavity in the glue injection mold 4 decreases gradually along the dragging direction such that the outlet 42 size of the glue injection mold 4 can define the predetermined thickness of the interface layer 120.

Thus, the pultruded core 110 is dragged from the inlet 41 of the glue injection mold 4 into the glue injection mold 4, and then is dragged through the outlet 42 after receiving the interface resin via the glue injection port 43, that is, an unhardened or ungelled interface layer 120 with a predetermined thickness can be formed on the surface of the pultruded core 110. Forming the interface layer 120 by using the glue injection mold 4 can realize continuous production and directly form the interface layer 120 with the predetermined thickness, which is of high efficiency and makes the thickness of the interface layer 120 uniform.

The tractor 7 can be disposed between the glue injection mold 4 and the pultrusion die 3, or can be disposed downstream of the glue injection mold 4 or the downstream of the production line. In the embodiment shown in FIG. 4, the tractor 7 is disposed between the glue injection mold 4 and the pultrusion die 3. Therefore, the forward dynamic source of the plank downstream of the tractor 7 can be a winding and packaging device.

Later, the pultruded core 110 applied with the interface layer 120 continues to be dragged to the texture applying device 5 downstream of the glue injection mode 4. The texture applying device 5 is used to apply texture to the unhardened or ungelled interface layer 120. Optionally, the texture applying device 5 comprises a scraping plate or a stamp of a texture shape (irregularly striped, latticed or scattered, as described above).

After that, the pultruded core 110 continues to be dragged to the supplementary heating device 6 at the texture applying device 5. In one example, since the hardening time of the interface layer 120 at room temperature takes 5 to 30 minutes, in order to improve production efficiency and avoid adhesion in subsequent processes, a temperature greater than 100° C. can be applied by the supplementary heating device 6 to the interface layer 120 for supplementary heating, such that the interface layer 120 is hardened to have a non-viscous hardened surface. Wherein, the supplementary heating device 6 can be an oven or a baking lamp.

After that, the pultruded plank continues to be dragged to the winding and packaging device located downstream to form a pultruded plank roll 100R for facilitation of transportation and use. Since the surface of the interface layer 120 has been hardened, there will be no adhesion of the interface layer 120 during winding.

As a preferred embodiment, fibre 111 can be a continuous fibre such as glass fibre, polyester or carbon fibre. The core resin may be at least one of the commercially available or homemade epoxy resin, vinyl ester resin or polyurethane resin, and the interface resin is preferably a commercially available or homemade resin with an isocyanate group, unsaturated bond and/or unsaturated group.

For example, the interface resin may be a compound with the isocyanate group, unsaturated bond and/or unsaturated group, or a combination of a compound with the isocyanate group and a compound with the unsaturated bond and/or unsaturated group.

In a specific example, the compounds with unsaturated bonds and/or unsaturated groups may be listed as compounds obtained from esterification of alkyl esters of (methyl) methyl acrylate, (methyl) ethyl acrylate, (methyl) butyl acrylate, 2-ethylhexyl (methyl) acrylate, (methyl) laurel acrylate (methyl) acrylic acid, polyhydric alcohols, i.e., (methyl) glycidyl acrylate, polyethylene glycol mono (methyl) acrylate with a number of 2 to 14 ethylene oxide alkyls, ethylene glycol bi(methyl) acrylate, polyethylene glycol bi(methyl) acrylate with a number of 2 to 14 ethylene oxide alkyls, polypropylene glycol bi(methyl) acrylate with a number of 2 to 14 propylene oxide alkyls, trimethylol propane bi(methyl) acrylate, bisphenol A diglycidyl ether acrylate adduct, diphthalate of (methyl) dihydroxyethyl acrylate, toluene diisocyanate adduct of (methyl) dihydroxyethyl acrylate, trimethylol propane tri(methyl) acrylate, pentaerythritol tri(methyl) acrylate, pentaerythritol tetra(methyl) acrylate, dipentaerythritol penta(methyl) acrylate, dipentaerythritol hexyl(methyl) acrylate, dipentaerythritol tri(methyl) acrylate, and α, β-diunsaturated carboxylic acid, as well as acrylic adduct of glycidyl-based compounds, such as trihydroxymethyl propane triglycidyl ether acrylic adduct. They can be used individually, or more than two are used together.

In a specific example, the compounds having an isocyanate group may be aliphatic, alicyclic, aromatic, and/or aromatic isocyanates, and preferably diisocyanate, such as three, four, five, six, seven or eight methylene diisocyanate, 2-methyl-pentamethylene-1, 5-diisocyanate, 2-ethyl-butylidene-1,4-diisocyanate, pentamethylene-1,5-diisocyanate, butylidene-1,4-diisocyanate, 1-isocyanate-3, 3, 5-trimethyl-5-isocyanate methylcyclohexane (isophorone diisocyanate, IPDI), hydrogenated phenyl dimethylene diisocyanate (HXDI), cyclohexane 1, 4-diisocyanate, diphenyl methane diisocyanate (MDI), 1,5-naphthalene diisocyanate (NDI), toluene diisocyanate (TDI), diphenyl methylene diisocyanate, 3,3′-dimethyl diphenyl diisocyanate, 1,2-diphenyl ethane diisocyanate, phenylene diisocyanate, etc. They can be used individually, or more than two are used together.

Exemplarily, when the interface resin consists of a complex resin, the complex resin may be composed of an isocyanate resin, a polyester resin, a vinyl ester resin, an epoxy resin, a modification component (a modifier that improves polarity and toughness), and a monomer.

For example, the interface resin preferably contains the isocyanate resin, i.e., the above compound with the isocyanate group, and the polyester resin, i.e., the compound with the unsaturated bond and/or unsaturated group. The isocyanate resin may preferably contain diphenyl methane diisocyanate. In this embodiment, the commercially available WANNATE® PM-200 of Wanhua Chemical is used for the isocyanate resin. Optionally, the isocyanate resin can also choose the commercially available Coxtron Desmodur® 44C, Desmodur® 44CP24, or Huntsman Surprasec 1051.

The polyester resin can be a bisphenol A polyester resin. In this embodiment, the polyester resin chooses the commercially available bisphenol A type unsaturated polyester of brand 3301. Optionally, the commercially available polyester resin such as UP197, UP197A or Atlac382 polyester can be used.

As an implementation, the polyester resin also contains reaction accelerators. For example, metal-based reaction accelerators include tin accelerator such as dibutyltin dilaurate, stannous caprylate, stannous chloride, etc.; iron accelerators such as ferric chloride, ferrocene, etc.; cobalt accelerators such as cobalt naphthenate, cobalt isocaptanate, etc.; zinc accelerators such as zinc isocrylate, etc. For another example, the reaction accelerators can also be ammonium accelerators. Optionally, the reaction accelerators may be contained in polyester resin components.

Such reaction accelerators can not only promote the curing of the polyester resin, but also can serve as the reaction catalyst of isocyanate resins, so as to eliminate the curing agent component in common bi-component polyurethane coatings. Moreover, since the polyester resin does not contain initiators, the reaction accelerators can be pre-mixed into the polyester resin.

As an implementation, the mass ratio of the isocyanate resin to the polyester resin is 1:3~2:3. Preferably, the mass ratio of the isocyanate resin to the polyester resin is 1:3~1:2. More preferably, the mass ratio of the isocyanate resin to the polyester resin is 1:3~7:13. Further preferably, the mass ratio of the isocyanate resin to the polyester resin is 3:7~7:13.

Further, the ratio of the isocyanate resin to the polyester resin can be adjusted according to the process conditions and environment in the range of the mass ratio, such that the viscosity of the interface resin before gel or hardening ranges from 80 to 800 CPS, so as to limit the thickness of the interface layer 120 and apply the texture.

According to the interface resin of the present application, the interface layer formed can achieve two bonding, i.e., the first bonding between the pultruded plank and the interface layer, and the second bonding between the plank containing the interface layer and the infusion resin.

Specifically, the —NCO group in the isocyanate resin can absorb water in the air and react to form high-polarity extended chain segments. After the interface resin is coated to the pultruded core, the isocyanate resin and the hydroxyl group on the surface of the pultruded plank can react to create hydrogen bond and covalent bonds, thus forming the first bonding. At the same time, the breaking of partial covalent bonds produces some free radicals which can be used to trigger polyester resin crosslinking.

Wherein, the mixed polyester resin can increase the crosslinking density of the interface layer on the three-dimensional level and improve the strength and chemical corrosion resistance thereof, endowing the planks with friction resistance during transportation and swelling corrosion resistance of the solvent and small molecular components in the infusion resin.

During the formation of the interface layer, —NH₂ is formed after the reaction of —NCO group, and —NH₂ can react with —NCO to form urea and polyurea. These are highly polar groups that can react with the subsequent infusion epoxy resin to form chemical bonds, thus forming a second bonding between the interface layer and the infusion resin. Exemplarily, epoxy resin perfusion is generally cured under a condition of being greater than 50° C. and maintained for 6 h, while some typical epoxy resin perfusion is cured at 60-80° C. and maintained for 10-12 hours, which can meet the chemical reaction conditions of the active groups in the isocyanate resin and the epoxy resin.

Therefore, the interface resin of the interface layer in this application can form chemical bonds with the core material of the pultruded plank and the infusion resin in the process of laminated infusion through the first bonding and the second bonding, such that the interface layer as well as the core material of the pultruded plank and the infusion resin have a high bonding strength.

Examples of isocyanate resin (WANNATE® PM-200) and polyester resin (Bisphenol A type unsaturated polyester, brand 3301) in the interface resin and different mass ratios are used below as Examples 1-6, and another examples of different types of adhesives as the interface resin serve as Contrast Examples 1-3.

The performance of the pultruded plank is evaluated by electronic drawing meter tests, and performance test and evaluation are made on the tensile shear strength of the pultruded plank after the laminated infusion. The results are shown in Table 1.

TABLE 1

| | Interface Layer | Tensile Shear | Electronic Drawing Meter Test | |
|---|---|---|---|---|
| | Composition | Strength/MPa | Strength/MPa | Failure Mode |
| Example 1 | Isocyanate resin:Polyester | / | / | / |
| | resin = 1:9 | | | |
| Example 2 | Isocyanate resin:Polyester | / | 6 | 80% b, 20% p |
| | resin = 1:4 | | | |
| Example 3 | Isocyanate resin:Polyester | 30 | 12.8 | 20% b, 40% h, |
| | resin = 1:3 | | | 40% p |
| Example 4 | Isocyanate resin:Polyester | 36.2 | 13.2 | 5% b, 60% h, |
| | resin = 3:7 | | | 35% p |
| Example 5 | Isocyanate resin:Polyester | 32.8 | 13.1 | 20% b, 50% h, |
| | resin = 7:13 | | | 30% p |
| Example 6 | Isocyanate resin:Polyester | 28.5 | 12.5 | 50% b, 20% h, |
| | resin = 2:3 | | | 30% p |
| Contrast | Bisphenol A epoxy vinyl | 28 | 8.5 | b |
| Example 1 | ester resin | | | |
| Contrast | Photocured epoxy binder | 22 | 11.5 | b, i, h |
| Example 2 | | | | |
| Contrast | Bi-component polyurethane | 27.1 | 9.8 | b |
| Example 3 | adhesive | | | |

Where, “p” refers to the failure in the pultruded plank; “b” refers to the failure in the interface layer; “i” refers to the failure in the perfused laminate plate (only for the tensile shear test); and “h” refers to the failure in the structural adhesive layer (only for the drawing test).

In addition, taking Example 3 as an example, “20% b” means that 20% of the sample is damaged in the interface layer; “40% h” means that 40% of the sample is damaged in the structural adhesive layer; “40% p” means that 40% of the sample is damaged in the pultruded plank, and so on.

Moreover, in combination with the failure mode of drawing force, the higher failure ratio (h %) of the structural adhesive layer of a device and the higher failure ratio (p %) in the pultruded plank, the more ideal the bonding form of the interface layer.

The interface layer comprising isocyanate resins and polyester resins in this application has excellent adhesion with both the pultruded plank and the base infused resin. The adhesives of other types in the Contrast Examples are insufficient in their own strength, or have a good bond with either the pultruded plank or the infusion resin.

Example 4 in this application and the pultruded plank with the stripper cloth are used below as the contrast example 4 to test the mechanical properties and compare with the standard requirements. The results are shown in Table 2. Wherein, interlayer shear strength is tested according to standard ISO 14130; tensile shear strength is tested according to standard EN 1465; and G1C interlayer fracture toughness is tested according to standard ASTM D5528.

TABLE 2

| | Interlayer | Tensile | Tensile | G1C Interlayer |
|---|---|---|---|---|
| | Shear | Shear | Strength | Fracture |
| Component | Strength/ | Strength/ | of 90° | Toughness/ |
| Testing | MPa | MPa | Joint/MPa | J · m⁻² |
| Standard | ≥50 | ≥30 | ≥35 | ≥900 |
| Requirements | | | | |
| Contrast | 51.90 | 31.4 | 39.10 | 1266 |
| Example 4 | | | | |
| Example 2 | 58.4 | 36.5 | 50.50 | 1217 |

It can be seen that the pultruded plank 100 with the interface layer 120 containing isocyanate resins and polyester resins in this application is stronger than the pultruded plank with the stripper cloth in many mechanical properties. The pultruded plank 100 with the interface layer 120 in this application ensures the structural integrity of the pultruded core 110 and will not cause the degradation of the mechanical properties. Moreover, compared with the pultruded plank having the stripper cloth, the pultruded plank 100 with the interface layer 120 in this application can not only meet the requirements of the standard, but also have significant advantages in terms of material cost and/or production cost.

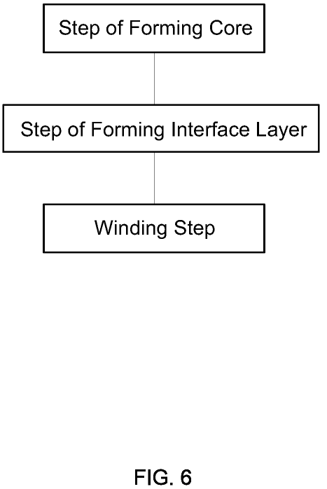

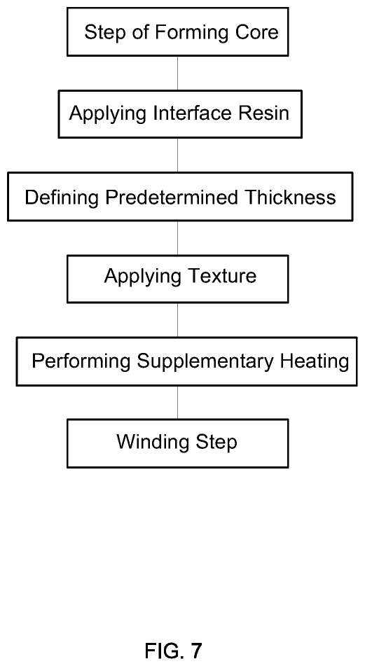

This application further provides a pultrusion preparation process for making the pultruded plank 100. Referring to FIG. 6 and FIG. 7, the pultrusion preparation process comprises a step of forming the pultruded core, a step of forming the interface layer and a winding step.

In the step of forming the pultruded core, the pultruded core 110 of the pultruded plank 100 is formed by dragging fibers 111 impregnated with the core resin through the pultrusion die 3 and being heated and solidified by the pultrusion die 3.

In the step of forming the interface layer, the interface resin is coated to at least one surface of the pultruded core 110 through a glue injection mold process, and the interface layer 120 is defined as having a predetermined thickness when not hardened or gelled. The texture is applied to the surface of the interface layer 120 after the unhardened or ungelled interface layer 120 has the predetermined thickness. After forming the texture, supplementary heating is carried out on the pultruded plank 100 to harden the surface of the interface layer 120. The temperature of supplementary heating is greater than 100° C. The interface layer 120 allows the pultruded plank 100 to be wound and packaged after hardening, and defines the adhesive surface of the pultruded plank 100.

In the winding step, the pultruded plank 100 is wound and packaged after the interface layer 120 is hardened.

The pultrusion preparation process according to this application forms a sanded-free interface layer 120 bonded surface without affecting the winding and packaging, and the bonded surface will not cause damage to the reinforced fibers 111, so that the pultruded plank 100 will not lose mechanical properties; and the pultruded plank formed by this pultrusion preparation process can be stacked and infused directly during the laminated infusion process to form the spar cap 20, without the need for additional surface activation of the plank and eliminating the use of consumables such as stripper cloth, which reduces production costs.

The processes and steps described above in all preferred embodiments are examples only. Unless an adverse effect occurs, the various processing operations can be performed in a different order from the order of the above processes. The sequence of steps in the processes can also be added, combined, or subtracted according to actual needs.

Unless otherwise defined, the technical and scientific terms used herein have the same meanings as commonly understood by those skilled in the technical field of the present application. The terms used herein are only for describing specific implementation purposes, and are not intended to limit the present application. A feature described in one embodiment herein can be applied to another embodiment alone or in combination with other features, unless the feature is not applicable in the other embodiment or otherwise stated.

The present application has been described through the above-mentioned embodiments, but it should be understood that the above-mentioned embodiments are only for the purpose of illustration and description. The present application is not limited to the above embodiments. More variations and modifications can be made according to the teachings of the present application, and these variations and modifications fall within the protection scope claimed by the present application.

1. A pultruded plank, which is used for a spar cap of a wind turbine blade, comprising:
a pultruded core made with reinforced fibers impregnated with a core resin, the reinforced fibers including glass fibers and/or carbon fibers;
a coated interface layer made with an interface resin present on at least one surface of the pultruded core, the interface layer allowing the pultruded plank to be wound and packaged after manufacturing, the interface resin containing an isocyanate resin and a polyester resin, and a mass ratio of the isocyanate resin to the polyester resin being 1:3~2:3;
wherein a surface of the interface layer forms a bonded surface on the pultruded plank, and the bonded surface is used to form a bonding interface between at least two pultruded planks.

2. The pultruded plank of claim 1, wherein,
the pultruded core is formed by dragging reinforced fibers impregnated with the core resin through a pultrusion die for heating and solidifying;
the interface layer is obtained by coating the interface resin on at least one surface of the pultruded core through a roller coating, brush coating or glue injection mold process and hardening;
the bonded surface without sanding can be used to form the bonding interface between at least two pultruded planks bonded with an infusion resin in the process of forming at least two of the pultruded planks by stacking and forming the spar cap by a laminated infusion process.

3. The pultruded plank of claim 2, wherein,
the interface layer is formed through a glue injection mold process, the glue injection mold located downstream of the pultrusion die along a dragging direction and comprising an inlet, an outlet, and a glue injection port arranged between the inlet and the outlet, and a height size of a cavity in the glue injection mold decreases gradually along the dragging direction such that an outlet size of the glue injection mold can define the interface layer to have a predetermined thickness;
the pultruded core is dragged from an inlet of the glue injection mold into the glue injection mold, and is dragged through the outlet after receiving the interface resin via the glue injection port to form a ungelled interface layer with the predetermined thickness on a surface of the pultruded core.

4. The pultruded plank of claim 3, wherein,
before the pultruded plank is wound and packaged, a temperature greater than 100° C. is applied to the interface layer by a supplementary heating device for heating such that the interface layer is hardened to avoid adhesion of the interface layer during winding and packaging;
wherein the supplementary heating device is located downstream of the glue injection mold along the dragging direction.

5. The pultruded plank of claim 4, wherein a surface of the interface layer is provided with a texture formed when the interface layer is not cured by a texture applying device that is located between the glue injection mold and the supplementary heating device and comprises a scraping plate or a stamp of a texture shape.

6. The pultruded plank of claim 5, wherein a shape of the texture is constructed to be irregularly striped, latticed or scattered.

7. The pultruded plank of claim 5, wherein,
the interface layer has the predetermined thickness of 0.02 to 0.2 mm; and/or
a thickness of the texture is the same as the predetermined thickness of the interface layer.

8. The pultruded plank of claim 1, wherein, the mass ratio of the isocyanate resin to the polyester resin is 1:3~1:2.

9. The pultruded plank of claim 1, wherein,
the isocyanate resin contains diphenyl methane diisocyanate; and/or
the polyester resin contains a bisphenol A type polyester resin and a reaction accelerator.

10. A spar cap of a wind turbine blade, comprising the pultruded plank of claim 1.

11. A wind turbine blade, comprising the pultruded plank of claim 1.

12. A pultrusion preparation process for making a pultruded plank for a spar cap of a wind turbine blade, wherein at least two pultruded planks form the spar cap by stacking and a laminated infusion process, comprising:
a step of forming a core in which a pultruded core of the pultruded plank is formed by dragging reinforced fibers impregnated with a core resin through a pultrusion die for heating and solidifying;
a step of forming an interface layer in which an interface resin is coated on at least one surface of the pultruded core through a glue injection mold process, and the interface layer is defined to have a predetermined thickness when not gelled, wherein the interface layer allows the pultruded plank to be wound and packaged after hardening, and defines a bonded surface of the pultruded plank, the interface resin containing an isocyanate resin and a polyester resin, and a mass ratio of the isocyanate resin to the polyester resin being 1:3~2:3;
a winding step in which the pultruded plank is wound and packaged after the interface layer is hardened.

13. The pultrusion preparation process of claim 12, wherein the step of forming the interface layer further comprises: applying a texture to a surface of the interface layer after the interface layer has a predetermined thickness and before the interface layer is gelled.

14. The pultrusion preparation process of claim 12, wherein the step of forming the interface layer further comprises: performing supplementary heating on the pultruded plank before winding and packaging at a supplementary heating temperature greater than 100° C.
